(19) United States
(12) Patent Application Publication
(10) Pub. No.: US 2026/0169471 A1
(43) Pub. Date: Jun. 18, 2026

(54) SYSTEMS AND METHODS FOR EVALUATING THE ACCURACY OF A RESPONSE TO QUALITATIVE CONTROLS

(71) Applicant: THE BANK OF NEW YORK MELLON, New York, NY (US)

(72) Inventors: Uddipt MITTER, New York, NY (US); Peter VIGLUCCI, New York, NY (US)

(21) Appl. No.: 19/042,346

(22) Filed: Jan. 31, 2025

(30) Foreign Application Priority Data
Dec. 12, 2024 (IN) 202411098444

(51) Int. Cl. G05B 23/02

(52) U.S. Cl. CPC G05B 23/0245

(57) ABSTRACT

Systems and methods for evaluating the accuracy of a response to qualitative controls standardize a first dataset; apply one or more labels to one or more data points of the first dataset; cleanse the first dataset; vectorize the first dataset; split the first dataset into a training subset, a testing subset, and a validating subset; deploy a model based on the training subset, the testing subset, and the validating subset; assess based on the model, a response to a prompt, wherein the assessment is of at least one of the completeness, accuracy, or validity of the response; and output the assessment.

### CROSS-REFERENCE TO RELATED APPLICATIONS

This application claims priority to India Patent Application No. 202411098444, filed Dec. 12, 2024. The subject matter of which is incorporated herein by reference in its entirety.

### BACKGROUND

In any business, operational risks are inherent to running day-to-day activities. To mitigate these risks such that they remain within acceptable boundaries, controls are put in place. These controls act as safeguards, reducing exposure to financial, operational, regulatory, and security threats. However, as the business environment evolves and becomes increasingly complex, the challenge of maintaining effective control over risks intensifies. Specifically, the explosion in the volume, velocity, and variety of data has made it incredibly difficult to enable these controls to continue to function effectively.

Asserting completeness, accuracy and validity of text entered in response to qualitative control assessments has traditionally involved manually reviewing the data by a qualified reviewer. However, challenges in ensuring the completeness, accuracy, and validity of text entered during qualitative control assessments stem from the growing complexity of modern operational environments, which span thousands of processes and technology stacks. Traditionally, this task has been handled manually by qualified reviewers who carefully examine data inputs, but as the volume of assessments increases, manual review becomes impractical, slow, and prone to human error. This method struggles to scale, often resulting in missed errors and incomplete assessments due to fatigue, oversight, or inconsistency among different reviewers.

Even semi-automated approaches, which combine manual oversight with automation tools, face similar challenges, as they still rely heavily on human intervention, are limited in their ability to adapt to diverse scenarios, and often cannot account for context-specific nuances in data entry. Fully automated systems, while faster, introduce their own set of limitations. They frequently depend on pre-set rules (e.g., using a configured blacklist of words to identify whether certain text is valid or not) or machine learning models that may not fully capture the complexity or variability of the processes they are assessing. These systems can generate false positives or negatives, failing to account for subtleties that a human reviewer might catch. Moreover, both manual and automated approaches tend to rely on sample-based testing, which reviews only a portion of the data, leaving gaps in coverage and increasing the likelihood that critical errors go unnoticed. This leaves organizations vulnerable to undetected risks, making it clear that current systems—whether manual, semi-automated, or automated—are insufficient for managing the complexities and scale of today's operational environments.

### SUMMARY

Aspects of the disclosure relate to methods, systems, and/or apparatuses for asserting the completeness, validity and accuracy of data made available in response to a qualitative control assessment using AI/ML models.

In some aspects, the techniques described herein relate to a method for evaluating the accuracy of a response to qualitative controls, including: standardizing, by a processor, a first dataset; applying, by the processor, one or more labels to one or more data points of the first dataset; cleansing, by the processor, the first dataset; vectorizing, by the processor, the first dataset; splitting, by the processor, the first dataset into a training subset, a testing subset, and a validating subset; deploying, by the processor, a model based on the training subset, the testing subset, and the validating subset; assessing, by the processor, based on the model, a response to a prompt, wherein the assessment is of at least one of the completeness, accuracy, or validity of the response; and outputting, by the processor, the assessment.

In some aspects, the techniques described herein relate to a method, wherein the first dataset is received from a continuous control monitoring (CCM) framework.

In some aspects, the techniques described herein relate to a method, wherein the first dataset is standardized based on a predefined format.

In some aspects, the techniques described herein relate to a method, wherein the one or more labels applied to the one or more data points of the first dataset are at least one of AI-generated labels and manually applied labels.

In some aspects, the techniques described herein relate to a method, wherein the AI-generated labels are generated based on one or more label training datasets.

In some aspects, the techniques described herein relate to a method, wherein cleansing the dataset further includes at least one of: identifying, by the processor, root forms of derived or inflected words in the first dataset; and replacing, by the processor, the derived or inflected words with the identified root forms in the corpus of the first dataset; or removing, by the processor, one or more predefined stop-words from the first dataset.

In some aspects, the techniques described herein relate to a method, wherein the training subset is used to train one or more models, the testing subset is used to evaluate a performance of the one or more models, and the validating subset is used for at least one of model selection and hyperparameter tuning of the one or more models.

In some aspects, the techniques described herein relate to a system for evaluating the accuracy of a response to qualitative controls, including: a computer system including one or more processors programmed with computer program instructions which, when executed, cause the computer system to: standardize a first dataset; apply one or more labels to one or more data points of the first dataset; cleanse the first dataset; vectorize the first dataset; split the first dataset into a training subset, a testing subset, and a validating subset; deploy a model based on the training subset, the testing subset, and the validating subset; assess based on the model, a response to a prompt, wherein the assessment is of at least one of the completeness, accuracy, or validity of the response; and output the assessment.

In some aspects, the techniques described herein relate to a system, wherein the first dataset is received from a continuous control monitoring (CCM) framework.

In some aspects, the techniques described herein relate to a system, wherein the first dataset is standardized based on a predefined format.

In some aspects, the techniques described herein relate to a system, wherein the one or more labels applied to the one or more data points of the first dataset are at least one of AI-generated labels and manually applied labels.

In some aspects, the techniques described herein relate to a system, wherein the AI-generated labels are generated based on one or more label training datasets.

In some aspects, the techniques described herein relate to a system, wherein, when cleansing the dataset, the computer system is further configured to at least one of: identify root forms of derived or inflected words in the first dataset; and replace the derived or inflected words with the identified root forms in the corpus of the first dataset; or remove one or more predefined stop-words from the first dataset.

In some aspects, the techniques described herein relate to a system, wherein the training subset is used to train one or more models, the testing subset is used to evaluate a performance of the one or more models, and the validating subset is used for at least one of model selection and hyperparameter tuning of the one or more models.

In some aspects, the techniques described herein relate to a non-transitory computer-readable media including instructions that, when executed by one or more processors, cause operations including: standardizing a first dataset; applying one or more labels to one or more data points of the first dataset; cleansing the first dataset; vectorizing the first dataset; splitting the first dataset into a training subset, a testing subset, and a validating subset; deploying a model based on the training subset, the testing subset, and the validating subset; assessing based on the model, a response to a prompt, wherein the assessment is of at least one of the completeness, accuracy, or validity of the response; and outputting the assessment.

In some aspects, the techniques described herein relate to a non-transitory computer-readable media, wherein the first dataset is received from a continuous control monitoring (CCM) framework; and wherein the first dataset is standardized based on a predefined format.

In some aspects, the techniques described herein relate to a non-transitory computer-readable media, wherein the one or more labels applied to the one or more data points of the first dataset are at least one of AI-generated labels and manually applied labels.

In some aspects, the techniques described herein relate to a non-transitory computer-readable media, wherein the AI-generated labels are generated based on one or more label training datasets.

In some aspects, the techniques described herein relate to a non-transitory computer-readable media, wherein cleansing the dataset further includes at least one of: identifying root forms of derived or inflected words in the first dataset; and replacing the derived or inflected words with the identified root forms in the corpus of the first dataset; or removing one or more predefined stop-words from the first dataset.

In some aspects, the techniques described herein relate to a non-transitory computer-readable media, wherein the training subset is used to train one or more models, the testing subset is used to evaluate a performance of the one or more models, and the validating subset is used for at least one of model selection and hyperparameter tuning of the one or more models.

Various other aspects, features, and advantages will be apparent through the detailed description and the drawings attached hereto. It is also to be understood that both the foregoing general description and the following detailed description are exemplary and not restrictive of the scope of the disclosure.

### BRIEF DESCRIPTION OF THE FIGURES

FIG. 1 depicts an illustrative system for evaluating the accuracy of a response to qualitative controls, in accordance with at least one embodiment

FIG. 2 depicts an example method for evaluating the accuracy of a response to qualitative controls, in accordance with at least one embodiment;

FIG. 3 depicts a representative data structure of a first dataset, according to at least one embodiment n, in accordance with at least one embodiment;

FIG. 4 depicts a labeled data set with a flagged entry on a graphical user interface, in accordance with at least one embodiment; and

FIG. 5 depicts a dataset and a corresponding vectorized dataset as shown on a graphical user interface, according to at least one embodiment;

FIG. 6 depicts an example computer system on which systems and methods described herein may be executed, in accordance with at least one embodiment.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

In the following description, for the purposes of explanation, numerous specific details are set forth in order to provide a thorough understanding of the various embodiments. It will be appreciated, however, by those having skill in the art, that the embodiments may be practiced without these specific details, or with an equivalent arrangement. In other cases, well-known structures and devices are shown in block diagram form in order to avoid unnecessarily obscuring the embodiments.

To mitigate the problems described herein, the inventors had to both invent solutions and, in some cases just as importantly, recognize problems overlooked (or not yet foreseen) by others in the field. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

The reliance on manual intervention in control monitoring, as outlined above, leads to significant scalability issues. In environments with complex and growing processes, control monitoring activities often rely on sample-based methods, where only a subset of the data is reviewed manually. This approach is limited in scope and fails to provide comprehensive oversight, especially when critical processes are involved. For instance, in the context of change management, a control might be responsible for ensuring that all Technology Request-for-Changes (RFCs) are raised appropriately. However, without proper oversight, the underlying systems and processes may be exposed to the risk of unauthorized changes being deployed in production IT systems. Conventional control techniques typically only verify whether mandatory fields are filled, but this does not guarantee that the information is complete, valid, or accurate. As the number of processes grows and regulatory pressures demand stricter governance, these shortcomings become even more pronounced.

In contrast to traditional approaches such as a sample-based approach, the methods and systems described herein offer more robust solutions for evaluating the accuracy of a response to qualitative controls. By providing reasonable assurance that the content entered in response to control checks is complete, valid, and accurate, embodiments of these systems and methods may reduce or eliminate the need for manual qualitative assessments. For example, these systems and methods may automatically determine whether qualitative content is fit-for-purpose as a control parameter, ensuring more effective oversight. As part of an automated Continuous Controls Monitoring (CCM) system, the systems and methods described herein may not only identify issues but also alert relevant users about potential deficiencies in the controls applied to a given process.

Current automated systems offer advantages over manual measures, but they also face challenges. One of the primary concerns is the quality of data used to train machine learning algorithms, which are central to these systems. The accuracy of an algorithm's output is highly dependent on the quality and representativeness of the data it is trained on. If the dataset is biased or incomplete, the algorithm will produce flawed results. To address this, embodiments of the systems and methods described herein use structured datasets with well-defined features derived from the underlying data as part of the Continuous Controls Monitoring regime, as described in detail herein. By doing so, the systems and methods may minimize bias and randomness, helping to provide more reliable outcomes.

Another challenge of present systems involves the consistency and stability of the data used for machine learning models. For the system to function properly, the data and feature inputs must remain stable over time. Any changes in the way data is generated, collected, or structured can affect the performance and accuracy of the model. To mitigate this risk, the systems and methods described herein utilize specific feature inputs generated during established Continuous Control Monitoring routines. These inputs are carefully selected and standardized, ensuring that the model is using reliable and consistent data. Additionally, the system is configured to handle dynamic content, capturing it in static frames as part of the evidence gathered during automated assessments, further enhancing the accuracy and completeness of the monitoring process.

Accordingly, embodiments of the systems and methods for evaluating the accuracy of a response to qualitative controls described herein provide an AI/ML approach to qualitative assessment of a given dataset with the intent of opining on its completeness, accuracy, and validity to support a CCM regime. The processes described herein anchor data quality and stability as outlined in the methods and systems mentioned herein, and provide an application of Natural Language Processing (NLP) capabilities to arrive at a reasonably sound assessment, providing a marked improvement over current systems and methods.

Furthermore, by embedding NLP capabilities within the CCM space, embodiments described herein extend the coverage of automation to include even qualitative evaluations. Current solutions are rules-driven deterministic systems which require rules to be created independently for every evaluation. Through the NLP-based systems and methods described herein, probabilistic CCM systems may be built which may self-learn based on the data that is being generated in the controls monitoring ecosystem.

Those with skill in the art will appreciate that inventive concepts described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions. These and other features are described in detail herein with reference to the foregoing figures.

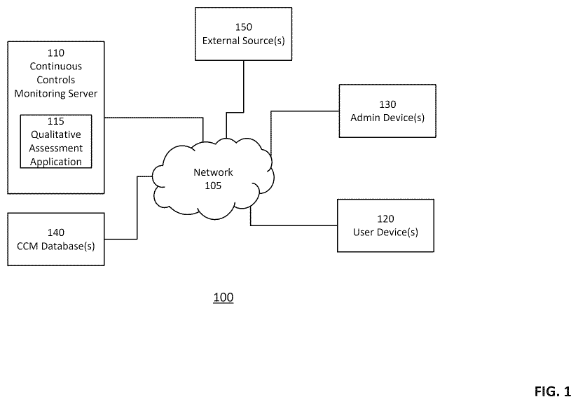

FIG. 1 depicts an illustrative system 100 for evaluating the accuracy of a response to qualitative controls, in accordance with at least one embodiment. FIG. 1 illustrates a functional block diagram of an embodiment of a controls management system 100 within which at least some of the disclosed techniques may be implemented. The controls management system 100 may be established to permit the automated or semi-automated evaluation of responses provided to qualitative controls, e.g., in a CCM platform, as described herein.

In some embodiments, various devices and applications described herein may be configured to communicate via network 105. In some embodiments, computing devices and servers described herein may communicate over network 105, which, in various embodiments, may be any of a diverse range of networks, each tailored to specific needs: Local Area Networks (LANs) linking devices within a confined area such as a home or office; Wide Area Networks (WANs) connecting devices across larger geographical areas, such as cities or countries; Metropolitan Area Networks (MANs) serving as intermediaries, connecting LANs within a city or region; wireless networks; cellular networks; Storage Area Networks (SANs); and/or Virtual Private Networks (VPNs) secure data over public networks. In some embodiments, network 105 may be any combination of the above, which may be a combination of private and public networks.

In some embodiments, each of the elements of controls management system 100 may be or may include applications executed on respective computing systems, though this need not always be the case. In some examples, one or more of the applications may be executed on a single computing system (which is not to suggest that such a computing system may not include multiple computing devices or nodes, or that each computing device or node need be co-located; indeed, a computing system including multiple servers that house multiple computing devices may be operated by a single entity and the multiple servers may be distributed, e.g., geographically). For example, in some embodiments, an entity may execute, on a server or other computing system, e.g., CCM server 110, a qualitative assessment application, e.g., qualitative assessment application 115. Moreover, in some examples, the entity may also provide users access to a qualitative assessment application on various user devices (e.g., devices 120 and/or 130, described herein), which may be a web-based application hosted by a computing system managed by or provisioned by the entity, or which communicates with such a computing system via an application programming interface (API). Accordingly, one or more of the devices/systems/elements depicted herein may communicate with one another via messages transmitted over network 105, such as the Internet and/or various other local area networks. For example, one or more applications may communicate via messages transmitted over network 105.

In some example embodiments, CCM server 110 may include, host, or otherwise execute qualitative assessment application 115. In some embodiments, qualitative assessment application 115 may be a user facing application with which a user interfaces to access various aspects of the systems and methods described herein. For example, one or more users may use one or more user devices 120, e.g., to input data (e.g., text or other inputs), e.g., responsive to requests for such data. For example, in the context of a CCM system, users may have various interactions with CCM server 110. As understood herein, CCM is an automated tool typically used by organizations to continuously track, assess, and report on the effectiveness of their internal controls, particularly those related to financial reporting, compliance, and operational efficiency, among others. In some embodiments, CCM server 110 may integrate with various enterprise systems, such as ERP platforms, and monitoring key controls in real-time to detect anomalies, risks, or deviations from established policies. It may reduce the reliance on periodic manual audits by providing ongoing visibility into control performance, which may help the organization respond more quickly to emerging issues.

Accordingly, in various embodiments, users may access user devices 120 to input or otherwise provide data and other information into CCM server 110. In some embodiments, users may input data through periodic updates, such as manually adding exceptions, explanations, or confirmations when the system flags potential issues. In some embodiments, end users may be staff members or other users within an organization who interact with the CCM system regularly, e.g., on a daily basis. For example, they may be responsible for reviewing and responding to alerts and notifications generated by the system when it detects a potential issue, risk, or policy deviation. These users may provide feedback by investigating flagged transactions or control breaches, offering explanations, and resolving discrepancies. For example, if the system flags an unauthorized access attempt a financial transaction exceeding a predefined threshold, or processing/execution errors, these end users may review the incident, determine whether it represents a legitimate concern or a false positive, and provide input regarding appropriate action.

Similarly, in some embodiments, administrators and/or other managers within an entity or organization may use admin devices 130 to input data and other information, e.g., with respect to the CCM system, its various users and settings, etc. For example, admin users, e.g., from internal audit, compliance, or IT departments, may be responsible for managing and/or configuring the CCM system. One or more of these users may be more focused on the quality of data entered into the system, and the overall efficiency of the system. For example, such users may set up the system's monitoring parameters and control rules, defining what types of risks or anomalies the system should focus on, what kinds of inputs are sufficiently responsive to issues or errors, etc. In some embodiments, admin users may establish thresholds (e.g., quality control standards, unusual data entries, etc.) and determine how the system flags certain data, activities, etc., ensuring that it aligns with organizational policies and compliance frameworks. In some embodiments, admin users may maintain and adjust the system as the organization evolves. They may respond to feedback from end users by fine-tuning the parameters to refine qualitative responses, reduce false positives or other errors. Admins may also integrate new data sources, adjust control rules as regulations change, or introduce new controls as needed.

In some embodiments, qualitative assessment application 115 may include a user interface through which a user may interact with controls management system 100 via various user devices, e.g., devices 120 and/or 130, and vice versa. For example, to assess a completeness of Change Description field in a Request for Change to systems in Production, an administrator may desire to configure or otherwise interact with qualitative assessment application 115. According to embodiments, the administrator, using admin device 130, may interact with a user interface of qualitative assessment application 115, and may adjust thresholds and/ratings for responses to qualitative assessments, input process options, data elements, prompt examples, etc., as described herein. Similarly, in some embodiments, qualitative assessment application 115 may be configured to monitor usage and/or inputs made by users via user devices 120 (e.g., the entering of a response in the Change Description field in the aforementioned Request for Change to systems in Production), and evaluate the accuracy of the response to qualitative controls, as described in detail herein.

In some example embodiments, qualitative assessment application 115 may be configured to coordinate with CCM database(s) 140 and external source(s) 150. CCM database 140 may be one or a collection of databases, configured to collect data relating to CCM server 110 and controls management system 100. For example, a data-pipeline may be set up as a part of an automated Continuous Controls Monitoring framework. This data may then be organized or standardized, e.g., into specific data-structures, as described herein, which may then be used to train a Machine Learning model, as described herein.

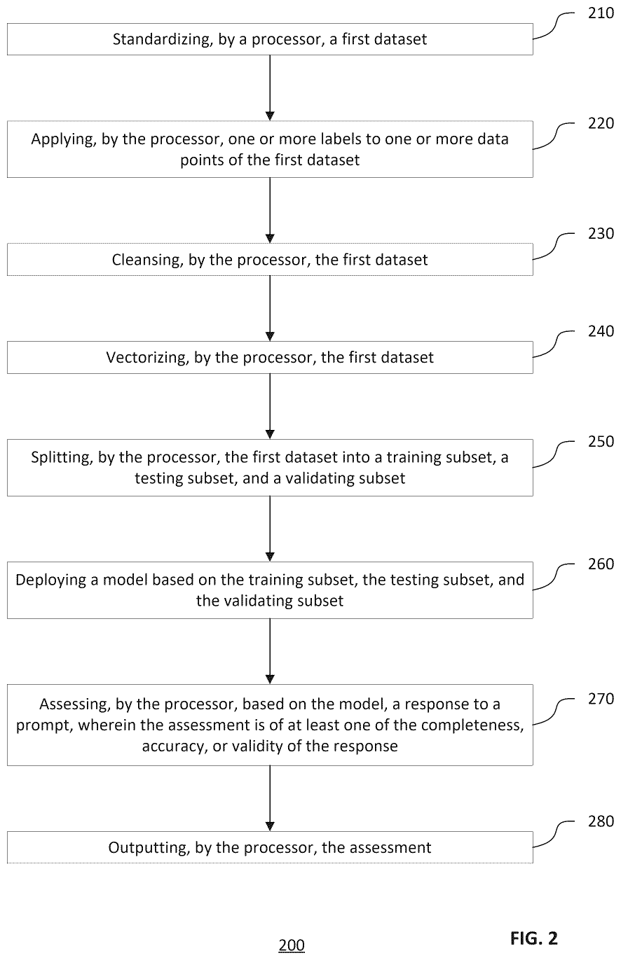

In some embodiments, external sources 150 may be any external source with which qualitative assessment application 115 may be configured to interact, e.g., external LLMs, Generative AI models, APIs, other organizations or databases, or even other separate systems within an organization, etc. These and other features of controls management system 100 will be further understood with reference to the controls management method 200 of FIG. 2, herein.

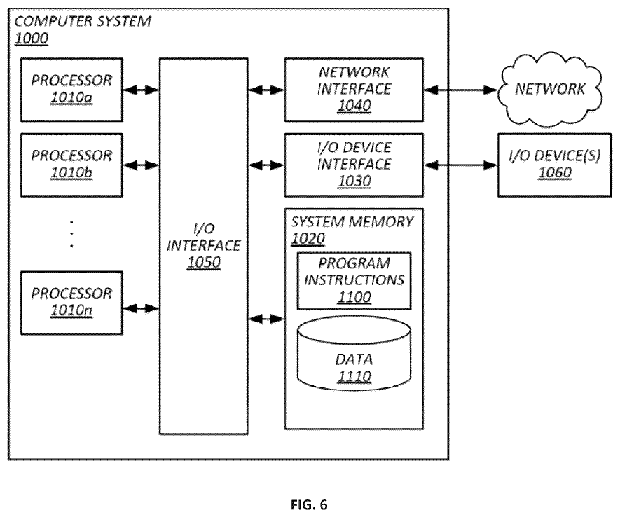

FIG. 2 depicts an example method evaluating the accuracy of a response to qualitative controls, in accordance with at least one embodiment. In various embodiments, method 200 may be implemented by qualitative assessment system 100, executing code in one or more processors therein. For example, in some embodiments, method 200 may be performed on a computer (e.g., computer system 1000 of FIG. 6) having one or more processors (e.g., processor(s) 1010 of FIG. 6) and memory (e.g., system memory 1020 of FIG. 6), and one or more code sets, applications, programs, modules, and/or other software stored in the memory and executing in or executed by one or more of the processor(s).

Method 200 begins at step 210 when a processor (e.g., of CCM server 110) is configured to standardize a first dataset. For example, the first dataset may be data received or retrieved from a database, e.g., CCM database 140. Such data may be, e.g., data having specified attributes as captured during an automated monitoring process and may be configured to expose dynamic content in static frames as a part of evidence collected during such automated assessments. Accordingly, as data from the system is captured, in some embodiments, the processor may be configured to standardize the first dataset, e.g., utilizing a standard format response from the CCM system. As noted herein, in some embodiments, data to be ingested may be standardized through a data-pipeline set up as a part of any automated Continuous Controls Monitoring framework. This may help to provide consistency in the data-structure when training a Machine Learning model, as described herein.

In some embodiments, data may be collected from various databases, systems, or departments—such as HR, finance, or IT—and may be fed into the pipeline, where the data may be automatically standardized, e.g., according to predefined rules. This may enable even disparate datasets to be harmonized, allowing the CCM system to function more efficiently and accurately.

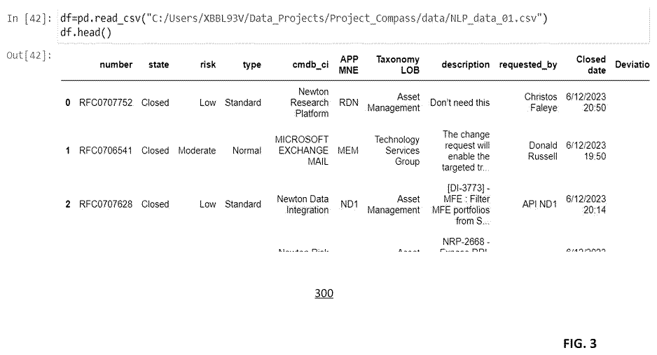

Turning briefly to FIG. 3, a representative data structure 300 of a first dataset is shown, according to at least one embodiment.

Returning to FIG. 2, at step 220, in some embodiments, the processor may be configured to apply one or more labels to one or more data points of the first dataset. For example, in some embodiments, the processor may be configured to utilize a generative AI model to create training data and embed the training data in an AI-enabling user-journey that allows for review and replacement of AI-generated labels, e.g., by the human agency. In some embodiments, this may improve the model accuracy substantially while increasing diversity.

In some embodiments, the processor may be configured to apply one or more labels to specific data points within the first dataset, e.g., related to systems monitoring, allowing for categorization or tagging of performance metrics, operational data, resource usage patterns, monitoring routines, etc. In some embodiments, this labeling process may be automated, with the processor applying labels based on predefined rules or thresholds. For example, in a system monitoring context, data points might be labeled according to CPU usage, memory consumption, or network latency, such as “high CPU usage,” “low memory,” or “network latency above threshold.” These labels may provide an organized view of system performance and help identify potential issues that need attention.

In some embodiments, the processor may utilize a generative AI model to apply labels dynamically based on real-time system data. For instance, the AI model may generate synthetic scenarios that reflect different system load conditions (e.g., peak usage times, underutilized resources, or hardware failures) and use these scenarios to train the system to recognize similar patterns in actual data. For example, when monitoring server performance, the AI model may label data points like “CPU spike during peak hours” or “unexpected memory usage pattern,” helping administrators or automated systems identify deviations from normal system performance.

In some embodiments, the processor may be configured to apply multi-dimensional labels to system metrics. For example, a server event may be labeled as both “high disk I/O” and “low network throughput,” reflecting multiple resource strains occurring simultaneously. This multi-labeling may provide a richer training data set, which may ultimately allow the system to perform a more comprehensive analysis by correlating various metrics and identifying deeper performance issues, such as bottlenecks caused by both disk and network limitations. By applying multiple labels to complex system behavior, the system may offer more precise insights into the evaluation of the accuracy of responses to qualitative controls.

In another embodiment, the processor may employ unsupervised learning techniques to autonomously identify and label system data that are not predefined. For example, a generative AI model may be implemented to detect an unusual increase in network traffic at certain times of day or identify a subtle trend in CPU usage that consistently leads to downtime in certain system environments. The processor may then automatically label these events as “unusual network traffic spikes” or “gradual CPU resource leak,” (or some other label) and provide for manual review of the accuracy of such labels. This capability may help surface system anomalies that might otherwise go unnoticed with traditional monitoring thresholds.

In some embodiments, the labeling process may be adaptive, allowing the processor to modify labels based on the continuous influx of new system data. For example, as usage patterns evolve—such as during a large deployment or an increase in remote work activity—the system may adjust its labeling criteria for resource utilization. A data point initially labeled as “moderate CPU usage” under normal conditions may be relabeled as “high CPU usage” if the system's baseline shifts due to higher demand.

In some embodiments, the inclusion of human agency in the labeling process may enhance both the accuracy and diversity of the model's predictions. For example, if the AI model tends to mislabel certain types of transactions or processes due to insufficient data in a particular category, human users may be provided with a prompt to intervene and re-label these cases correctly.

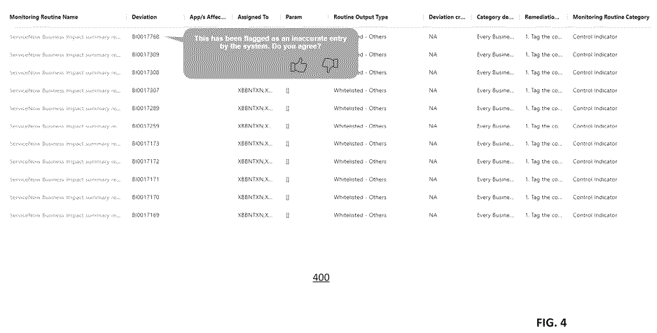

Turning briefly to FIG. 4, a labeled data set 400 with a flagged entry is shown on a graphical user interface, according to at least one embodiment. In this example, the system has flagged the entry as inaccurate, and requests confirmation from a user. This iterative process of reviewing and replacing AI-generated labels may enrich the training data by incorporating a broader range of perspectives and real-world nuances, which the model might not have originally captured. For instance, an AI model trained solely on financial transactions from large corporations might misinterpret transactions from small businesses or non-profits, but with human intervention, these distinctions can be made more accurately. Over time, this process may improve model accuracy such that the system is able to handle a more diverse set of data inputs.

Returning to FIG. 2, at step 230, in some embodiments, the processor may be configured to cleanse the first dataset. For example, in some embodiments, the processor may be configured to clean the text in the first dataset, e.g., by removing stop-words, stemming, and/or lemmatizing the text, etc., for accuracy. In some embodiments, the processor may find the root forms of derived or inflected words and use them in the corpus for the training dataset. In some embodiments, the processor may remove common stop-words to further clean the dataset. For example, in some embodiments, standard Python libraries may be implemented which identify common stop-words, punctuation, etc., which may be filtered out.

In some embodiments, the processor may be configured to cleanse any text in the first dataset before the data is converted into vectors, as described herein. Text cleansing may be a valuable step in natural language processing (NLP) tasks, as it may improve the quality of the data, leading to better accuracy in machine learning models. In various embodiments, one or more of a variety of techniques may be used in this cleansing process, such as removing stop-words, stemming, and lemmatization, which enable the text data to be both clean and consistent for the training models.

Stop-words refer to common words that appear frequently in a language but may provide little to no useful information for the purposes of analysis. Examples of stop-words in English include words like “the,” “and,” “is,” “in,” and “of.” These words occur so often in text that they often do not add meaningful insights into the content's structure or intent, and leaving them in the dataset may create noise in the model.

In some embodiments, the processor may be configured to remove stop-words, e.g., to reduce the dimensionality of the dataset and increase model efficiency. By eliminating these frequent, low-value words, the system may increase the likelihood that only relevant and meaningful words remain, thus improving the performance of downstream tasks such as text classification or sentiment analysis. For example, in Python, libraries like NLTK or spaCy include predefined lists of stop-words that the processor may filter out, thus streamlining the cleaning process.

In some embodiments, the processor may perform stemming on the text. Stemming is the process of reducing a word to its base or root form, e.g., by cutting off suffixes or prefixes, or otherwise revising the word. For example, the words “running,” “runner,” and “ran” could all be reduced to the stem “run.” A goal of stemming is to group words with the same root meaning together, so that they are treated as the same word in the analysis, even though they might appear in different grammatical forms. Stemming typically uses basic heuristics to remove affixes, which makes it computationally efficient. However, one caution is that this may sometimes produce non-dictionary words or stems that are not valid, such as reducing “better” to “bett.” Despite this, stemming may significantly reduce the number of unique words in a dataset, leading to more generalized and concise data representation. In some embodiments, the processor may apply stemming using tools such as, for example, the Porter Stemmer or Snowball Stemmer from popular libraries like NLTK.

In some embodiments, the processor may perform lemmatization on the text. Lemmatization reduces words to their lemma, which is the dictionary form of the word. Lemmatization takes into account the grammatical context of the word, such as its part of speech, and provides that the root word is valid in the language. For example, while stemming might reduce “better” to “bett,” lemmatization would correctly reduce it to “good” based on its grammatical meaning. Lemmatization may improve the accuracy of the dataset, as it may provide that each word is transformed into its proper base form, leading to fewer errors in downstream tasks. For example, the words “is,” “am,” and “are” may all be lemmatized to “be,” ensuring that verbs in different tenses are properly represented. In some embodiments, the processor may use lemmatization libraries such as, for example, WordNetLemmatizer from NLTK or spaCy's built-in lemmatization functions to achieve the desired result.

In some embodiments, the processor may combine stop-words removal, stemming, and/or lemmatization to cleanse the text dataset in a more comprehensive manner. Each technique may address a different aspect of the text cleaning process: stop-words removal reduces noise, stemming or lemmatization reduces word variation, and lemmatization, in particular, improves grammatical accuracy. By applying these techniques, the processor may enable the text data used for training machine learning models to be more compact, consistent, and meaningful. For example, after removing stop-words, a sentence like “The runner was running quickly in the race” may undergo stemming to become “runner run quick race” or lemmatization to become “runner be run quick race.” Both methods aim to strip the sentence down to its core meaning while eliminating unnecessary variations that may otherwise confuse or burden the model. In various embodiments, stemming may be preferred for its speed, while lemmatization may be used when higher accuracy and linguistic consistency are important.

In some embodiments, the cleansing of the text in the first dataset through stop-words removal, stemming, and/or lemmatization may enhance the training process of machine learning models described herein. By reducing noise and consolidating word forms, the dataset may become more manageable, and the resulting feature vectors (when converted into numerical form) become less sparse and more representative of the core concepts within the text. This increases the model's ability to generalize from the training data and improves the accuracy of the predictions it makes. Moreover, by finding the root forms of derived or inflected words, in some embodiments, the processor may enable words with similar meanings to be treated the same in the model, which reduces dimensionality and improves the robustness of the model's learning. For example, if the system is tasked with identifying performance issues in system logs, it may benefit from recognizing that “running,” “ran,” and “runs” all refer to the same action, regardless of tense.

In addition to, or as an alternative to, stop-words removal, stemming, and lemmatization, in some embodiments, other techniques may be used to cleanse corpus data, enhancing the quality of the dataset for machine learning models. These methods may further refine the data by addressing issues such as irrelevant characters, inconsistencies, and/or redundant information that may negatively impact the performance of NLP/ML models.

For example, in some embodiments, the processor may be configured to convert all text to lowercase as part of the cleansing process. This step may provide consistency in the dataset, as NLP models treat “Word” and “word” as different tokens if the text is case-sensitive. By converting all capitalized text to lowercase, words that appear in different cases may be treated as the same word, which helps reduce the dimensionality of the data and help provide that capitalized words at the beginning of sentences do not introduce unnecessary variability. For example, the words “Server” and “server” would be standardized to “server,” ensuring uniformity.

In some embodiments, the processor may remove punctuation marks such as periods, commas, quotation marks, and colons, which generally do not add semantic value in many NLP applications. For example, punctuation may be removed when processing text logs in system monitoring datasets, as these symbols do not typically convey relevant meaning. Removing punctuation may reduce noise and simplify the tokenization process, ensuring that only words and meaningful numbers are processed by the system. However, there are some cases, such as sentiment analysis, where punctuation like exclamation marks may indicate emotion, and thus may be retained depending on the use case.

In some embodiments, the processor may be configured to remove special characters (e.g., @, #, $, %, &) and numbers from the text, as these symbols may not carry relevant information in certain types of corpus data. This step is particularly useful when analyzing system logs or other types of unstructured text where such characters may be present as part of the formatting rather than as essential content. For example, log data may contain timestamps, IDs, or system codes that aren't necessary for the NLP model to process and may be removed to simplify the dataset. However, in some cases, numbers or specific symbols may hold meaning, such as in datasets involving product prices or system uptime values. In these instances, the processor may selectively retain or normalize numeric data instead of removing it completely.

In some embodiments, the processor may tokenize text during the cleansing of the corpus data. Tokenization is the process of splitting text into individual units called tokens, which may be words, phrases, or even individual characters. In some embodiments, the processor may use word-level tokenization to split a text string into words, which may enable easier analysis and processing. For example, the sentence “The server is running slowly” may be tokenized into the individual words: [“The”, “server”, “is”, “running”, “slowly”]. Tokenization may enable the model to work with word units independently, increasing accuracy in text vectorization and subsequent modeling. In some embodiments, sub-word tokenization or character-level tokenization may be employed. Sub-word tokenization (such as byte-pair encoding or WordPiece tokenization) may be useful when the dataset contains uncommon words or morphologically complex words, ensuring that even rare or unknown words may be broken down into recognizable units.

In some embodiments, the processor may implement spell correction to improve the quality of the text data. This process involves identifying and correcting misspelled words in the corpus, ensuring that errors in the text do not interfere with the analysis. Spell correction may be especially useful when dealing with user-generated content or system logs that may contain typographical errors. For example, if the word “serrver” appears frequently in a dataset, correcting it to “server” provides consistency in the data and reduces noise that may confuse the model.

In some embodiments, the processor may be configured to remove duplicates in the corpus data. In some datasets, especially those generated by systems or user interactions, certain entries or text strings may appear multiple times. For example, in system monitoring logs, a recurring event like “Server restarted successfully” may appear repeatedly. Removing these redundant entries may help such that the dataset is more efficient and not biased by repetitive data, which may skew the model's learning process.

In some embodiments, the processor may be configured to remove URLs, emails, and HTML tags from the dataset, particularly if the data comes from web scraping or system-generated content. These elements usually do not provide useful information for NLP models unless specifically needed for tasks like entity extraction. By removing these irrelevant elements, the dataset becomes cleaner and easier to work with. For example, the text “<p>Server uptime is 99%</p>” may be stripped of the HTML tags, leaving only “Server uptime is 99%.”

In some embodiments, the processor may implement text normalization to provide consistency. This may involve converting contractions into their full form (e.g., changing “isn't” to “is not”) or standardizing abbreviations and acronyms. For example, in system monitoring data, acronyms such as “CPU” and “RAM” may be standardized to their full forms (“Central Processing Unit” and “Random Access Memory”) to avoid confusion or inconsistencies in labeling. In some embodiments, text normalization may also include removing case variations and normalizing date and time formats. For example, “03/14/2024” and “March 14, 2024” may both be converted to the same standardized format, reducing variability in the dataset.

In some embodiments, particularly in large and diverse datasets, the processor may be configured to remove outliers or irrelevant data. Outliers may refer to rare or unusual data points that do not follow typical patterns and may disrupt the model's learning process. In a systems monitoring context, an example may be a set of logs that record abnormal, one-off events that do not reflect the regular system behavior. Removing such outliers may help such that the machine learning model does not overfit to rare, non-representative cases, improving its generalizability.

By applying these various cleansing techniques—removing stop-words, performing stemming or lemmatization, converting to lowercase, removing punctuation and special characters, tokenizing, correcting spelling, normalizing text, etc. —the processor may significantly improve the quality and consistency of the dataset. Cleaned and structured text data is easier to convert into vectors for machine learning models, which may reduce the dimensionality of the data, enhance accuracy, and improve overall performance.

At step 240, in some embodiments, the processor may be configured to vectorize the first dataset. Vectorization is the process of converting textual data into numerical representations so that machine learning models, which cannot directly process raw text, can process the data. Each word or phrase in the dataset is transformed into a corresponding numeric vector that encodes the semantic or syntactic properties of the text.

For example, in some embodiments, the processor may be configured to generate word embeddings as part of the vectorization process. Word embeddings are dense, low-dimensional representations of words in a vector space, where semantically similar words are located closer to each other. Popular methods to generate these embeddings include techniques such as Word2Vec, GloVe, or TF-IDF (Term Frequency-Inverse Document Frequency). These methods encode the relationships between words based on their context within the dataset, capturing nuanced meanings and associations. Since AI and machine learning models cannot directly interpret text, converting all the words in the corpus into numerical vectors enables the system to analyze the text, detect patterns, and make predictions. In some embodiments, this process may be implemented using, e.g., standard Python (or other) libraries such as scikit-learn, gensim, or spaCy, which provide built-in functions for text vectorization and generating word embeddings. These libraries streamline the process, enabling more efficient and accurate machine learning model training based on the vectorized text data.

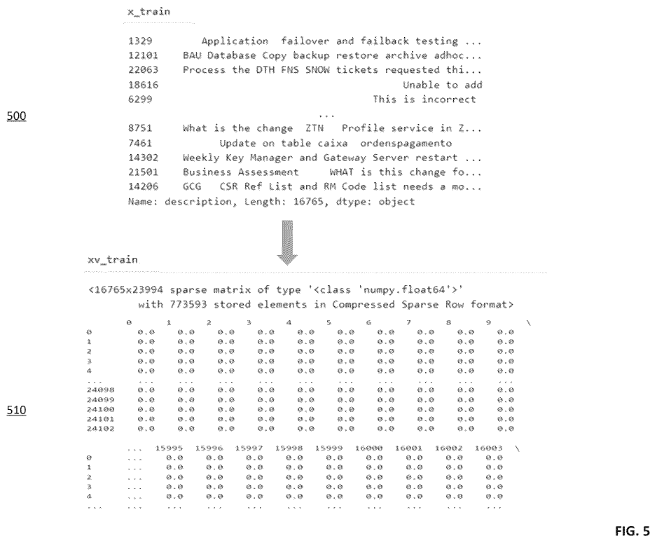

Turning briefly to FIG. 5, a dataset 500 and a corresponding vectorized dataset 510 are shown on a graphical user interface, according to at least one embodiment.

Returning to FIG. 2, at step 250, in some embodiments, the processor may be configured to split the first dataset into a training subset, a testing subset, and a validating subset. These subsets serve different purposes in the machine learning process, ensuring that models are trained, evaluated, and fine-tuned for optimal performance. The vectorized data from the first dataset may be passed through these subsets to train and assess the accuracy of various machine learning models. In some embodiments, the training subset may be used to train the machine learning models. This is typically the largest portion of the dataset, containing the majority of the data, and is where the models learn patterns, relationships, and features from the input data. For example, in some embodiments, the processor may use the training dataset to fit models such as logistic regression, Naive Bayes, and/or random forest classifiers. Logistic regression is often used for binary or multi-class classification problems, predicting the probability of certain outcomes. Naive Bayes is a probabilistic classifier based on Bayes'Theorem, commonly used for text classification tasks like spam filtering or sentiment analysis. The random forest classifier is an ensemble learning method that uses multiple decision trees to make more robust predictions. Each of these models has its strengths depending on the nature of the problem, and the training subset is where they first encounter the data and build their internal representations.

In some embodiments, once the models have been trained on the training dataset, the testing subset may be used to evaluate the performance of the models. This dataset consists of unseen data that the models did not encounter during the training phase. This helps such that the models generalize well to new, previously unseen data and are not overfitting to the training data. By comparing the model's predictions to the actual labels in the testing subset, the processor may calculate performance metrics such as accuracy, precision, recall, and F1-score. These metrics may further provide insights into how well the models are performing and whether they are making correct predictions on real-world data.

In some embodiments, a validation subset may be used for model selection and/or hyperparameter tuning. In some embodiments, the processor may use this subset to compare the performance of different models and select the best one. Additionally, hyperparameter tuning involves adjusting the settings of the models (such as, e.g., the number of trees in a random forest or the regularization strength in logistic regression) to optimize performance. The validation subset may help the processor identify the most effective model configuration by trying out different hyperparameter values and determining which yields the highest accuracy or other desired performance measures. It is important to note that the validation dataset is kept separate from the test data to avoid bias during the evaluation process.

By splitting the dataset into at least these three subsets, the processor may enable the model to be properly trained, tested, and fine-tuned. The training subset may allow the model to learn from the data, the testing subset may measure how well it generalizes to unseen data, and the validation subset may optimize the model for maximum performance. This process of splitting the data and using these subsets may enable a more robust and reliable machine learning pipeline, leading to better results in real-world applications.

At step 260, in some embodiments, the processor may be configured to deploy a model based on the training subset, the testing subset, and the validating subset. In some embodiments, the processor may be configured to deploy one or more of the machine learning models after it has been thoroughly trained, tested, and validated using the respective subsets: the training subset, testing subset, and validation subset. This deployment phase may occur once the model has demonstrated sufficient performance and reliability during the earlier stages, making it suitable for use in real-world scenarios. In some embodiments, deployed models may be constantly, regularly, or periodically updated, such that the deployed model is always providing the most accurate results. Once the model has been trained, tested, and validated, the processor may be configured to deploy the model into production. In the context of deployment, the model may be integrated into the operational environment where it can start making assessments based on live, real-time data.

At step 270, in some embodiments, the processor may be configured to assess, based on the model, a response to a prompt. In some embodiments, the assessment may be of at least one of the completeness, accuracy, or validity of a response, e.g., to a controls inquiry. In some embodiments, a qualitative assessment of controls, e.g., across text-based vectors, may be executed using, e.g., a native NLP implementation or by utilizing one or more Large Language Models. For example, a user may be prompted to enter text, e.g., in a dialog box, regarding implementation of a Material Change Notice (MCN) change. MCN refers to a formal notification issued to stakeholders, such managers, internal departments, etc., when there is a significant or “material” change in a product, process, service, or system that may affect its quality, functionality, performance, compliance, or supply. These changes are typically critical enough that they require communication, approval, or acknowledgment from involved parties to allow proper alignment and continued operation.

In example embodiments, a user may enter, e.g., “not applicable,” “not done,” “this description is not needed,” or the like. While technically one of these responses may answer the query, an assessment of the completeness, accuracy, and/or validity of the response by the system, based on the model, may indicate that such a response is incorrect or incomplete. In contrast, a response stating that “MCN changes are being rolled out to support Program Increment 3,” “MCN changes being implemented to support the multi-dataset functionality,” or the like may be considered sufficiently complete, accurate, and/or valid such that it is identified as a correct response.

In some embodiments, the processor may be configured to provide further feedback, such as, e.g., an indication of what information may be missing from an incomplete answer, examples of sufficient answers, etc. In some embodiments, the processor be configured to provide a grade or other indication of the relative completeness, accuracy, and/or validity of the response, e.g., with respect to representative answers.

Finally, at step 280, in some embodiments, the processor may be configured to output the assessment. For example, in some embodiments, the processor may generate a notification based on the assessment. In some embodiments, the notification may be displayed on a user interface of the user who entered the response. In some embodiments, a message or other prompt may be displayed or convey to the user. In some embodiments, a notification may be sent to other users, e.g., an administrator, manager, etc.

Some embodiments may execute the above operations on a computer system, such as the computer system of FIG. 6, which is a diagram that illustrates a computing system 1000 in accordance with embodiments of the present techniques. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, external (e.g., third party) content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B may include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

While the systems and methods described herein have generally be described with respect to a single legacy language being translated to a modernized coding language (e.g., one-to-one translation of a first language to a second language), in various embodiments, the same processes may be implemented in a one-to-many framework. For example, in some embodiments, a user may indicate one or more second languages to which a first language is to be translated. Additionally or alternatively, in some embodiments, one or more translation recommendations may be provided (as described herein) for multiple translations. In either event, embodiments of the systems and methods described herein may be configured to process multiple translations, e.g., in parallel and/or in series (e.g., based on an identified priority), as described herein.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for evaluating the accuracy of a response to qualitative controls, comprising:
standardizing, by a processor, a first dataset;
applying, by the processor, one or more labels to one or more data points of the first dataset;
cleansing, by the processor, the first dataset;
vectorizing, by the processor, the first dataset;
splitting, by the processor, the first dataset into a training subset, a testing subset, and a validating subset;
deploying, by the processor, a model based on the training subset, the testing subset, and the validating subset;
assessing, by the processor, based on the model, a response to a prompt, wherein the assessment is of at least one of the completeness, accuracy, or validity of the response; and
outputting, by the processor, the assessment.

2. The method as in claim 1, wherein the first dataset is received from a continuous control monitoring (CCM) framework.

3. The method as in claim 1, wherein the first dataset is standardized based on a predefined format.

4. The method as in claim 1, wherein the one or more labels applied to the one or more data points of the first dataset are at least one of AI-generated labels and manually applied labels.

5. The method as in claim 4, wherein the AI-generated labels are generated based on one or more label training datasets.

6. The method as in claim 1, wherein cleansing the dataset further comprises at least one of:
identifying, by the processor, root forms of derived or inflected words in the first dataset; and
replacing, by the processor, the derived or inflected words with the identified root forms in the corpus of the first dataset; or
removing, by the processor, one or more predefined stop-words from the first dataset.

7. The method as in claim 1, wherein the training subset is used to train one or more models, the testing subset is used to evaluate a performance of the one or more models, and the validating subset is used for at least one of model selection and hyperparameter tuning of the one or more models.

8. A system for evaluating the accuracy of a response to qualitative controls, comprising:
a computer system comprising one or more processors programmed with computer program instructions which, when executed, cause the computer system to:
standardize a first dataset;
apply one or more labels to one or more data points of the first dataset;
cleanse the first dataset;
vectorize the first dataset;
split the first dataset into a training subset, a testing subset, and a validating subset;
deploy a model based on the training subset, the testing subset, and the validating subset;
assess based on the model, a response to a prompt, wherein the assessment is of at least one of the completeness, accuracy, or validity of the response; and
output the assessment.

9. The system as in claim 8, wherein the first dataset is received from a continuous control monitoring (CCM) framework.

10. The system as in claim 8, wherein the first dataset is standardized based on a predefined format.

11. The system as in claim 8, wherein the one or more labels applied to the one or more data points of the first dataset are at least one of AI-generated labels and manually applied labels.

12. The system as in claim 11, wherein the AI-generated labels are generated based on one or more label training datasets.

13. The system as in claim 8, wherein, when cleansing the dataset, the computer system is further configured to at least one of:
identify root forms of derived or inflected words in the first dataset; and
replace the derived or inflected words with the identified root forms in the corpus of the first dataset; or
remove one or more predefined stop-words from the first dataset.

14. The system as in claim 8, wherein the training subset is used to train one or more models, the testing subset is used to evaluate a performance of the one or more models, and the validating subset is used for at least one of model selection and hyperparameter tuning of the one or more models.

15. A non-transitory computer-readable media comprising instructions that, when executed by one or more processors, cause operations comprising:
standardizing a first dataset;
applying one or more labels to one or more data points of the first dataset;
cleansing the first dataset;
vectorizing the first dataset;
splitting the first dataset into a training subset, a testing subset, and a validating subset;
deploying a model based on the training subset, the testing subset, and the validating subset;
assessing based on the model, a response to a prompt, wherein the assessment is of at least one of the completeness, accuracy, or validity of the response; and
outputting the assessment.

16. The non-transitory computer-readable media as in claim 15, wherein the first dataset is received from a continuous control monitoring (CCM) framework; and wherein the first dataset is standardized based on a predefined format.

17. The non-transitory computer-readable media as in claim 15, wherein the one or more labels applied to the one or more data points of the first dataset are at least one of AI-generated labels and manually applied labels.

18. The non-transitory computer-readable media as in claim 17, wherein the AI-generated labels are generated based on one or more label training datasets.

19. The non-transitory computer-readable media as in claim 15, wherein cleansing the dataset further comprises at least one of:
identifying root forms of derived or inflected words in the first dataset; and
replacing the derived or inflected words with the identified root forms in the corpus of the first dataset; or
removing one or more predefined stop-words from the first dataset.

20. The non-transitory computer-readable media as in claim 15, wherein the training subset is used to train one or more models, the testing subset is used to evaluate a performance of the one or more models, and the validating subset is used for at least one of model selection and hyperparameter tuning of the one or more models.
